(19) United States
(12) Patent Application Publication
(10) Pub. No.: US 2026/0038129 A1
(43) Pub. Date: Feb. 5, 2026

(54) OBJECT TRACKING DEVICE AND METHOD FOR ROBOT MANIPULATING MOVING OBJECT

(71) Applicant: SEOUL NATIONAL UNIVERSITY R&DB FOUNDATION, Seoul (KR)

(72) Inventors: Byoung-Tak ZHANG, Seoul (KR); Hyunseo KIM, Seoul (KR); Hye Jung YOON, Seoul (KR); Minji KIM, Seoul (KR); Dong-Sig HAN, Seoul (KR)

(21) Appl. No.: 19/357,611

(22) Filed: Oct. 14, 2025

Related U.S. Application Data
(63) Continuation of application No. PCT/KR2023/011511, filed on Aug. 4, 2023.

(30) Foreign Application Priority Data
May 25, 2023 (KR) 10-2023-0067656

(51) Int. Cl. G06T 7/246; B25J 9/16; G06T 7/73

(52) U.S. Cl. CPC G06T 7/248; B25J 9/1697; G06T 7/74; G06T 2207/10016; G06T 2207/20081

(57) ABSTRACT

The embodiments described herein are directed to an object tracking device and method for a robot that manipulates a moving object. An object tracking device according to one embodiment includes memory configured to store data and an object tracking model, and a controller including at least one processor and configured to determine whether a target object has exited from a frame image by using the object tracking model.

### CROSS-REFERENCE TO RELATED APPLICATION

This application is a continuation application of the International Application No. PCT/KR2023/011511, filed on Aug. 4, 2023, which claims priority from Korean Patent Application No. 10-2023-0067656, filed on May 25, 2023, which is also incorporated herein by reference in its entirety.

### TECHNICAL FIELD

The embodiments disclosed herein relate to an object tracking device and method for a robot that manipulates a moving object, and more particularly, to an object tracking device and method that enable a robot to become aware of the presence or absence of an object to safely manipulate a moving object.

The present study was conducted as a result of research on the following tasks of Korean Ministry of Science and ICT and the Institute of Information & Communications Technology Planning & Evaluation:
1) (IITP-2022-0-00951-002) “Development of Uncertainty-Aware Agents Learning by Asking Questions” Task under the Human-Centered AI Core Source Technology Development Project;
2) (IITP-2022-0-00953-002) “Self-directed AI Agents with Problem-solving Capability” Task under the Human-Centered AI Core Source Technology Development Project;
3) (IITP-2021-0-01343-003) “Artificial Intelligence Graduate School Program (Seoul National University)” Task under the Information, Communications, and Broadcasting Innovation Talent Development Project; and
4) (IITP-2021-0-02068-003) “Artificial Intelligence Innovation Hub” Task under the Information, Communications, and Broadcasting Innovation Talent Development Project.

### BACKGROUND ART

Various real-world applications of robots are emerging, such as manufacturing products in factories, preparing ordered beverages, or kneading pizza dough. For robots to manipulate objects, it is essential to determine the location of a target object. Currently, the location of a target object is calculated using a ceiling camera capable of observing both a robot arm and an object or a hand camera mounted on a robot arm and configured to capture first-person perspective images, and then the robot arm is moved to the corresponding location and manipulates the object. In the case of the ceiling camera, it may be installed in a fixed location to reliably determine the location of a robot.

However, it is difficult to install a ceiling camera capable of generating global coordinates in every workspace, and the location of the ceiling camera may be changed in the event of an unexpected situation. Accordingly, there are cases where it is necessary to mount a hand camera only on a robot arm, identify the location of a target object through a video captured by the hand camera, and then manipulate a robot. In the case of the hand camera, the camera is constantly moving, so that external factors such as light make it difficult to reliably recognize objects. To overcome this problem, objects captured by the hand camera may be recognized using object tracking technology using an artificial neural network, as in Korean Patent No. 10-1912569.

Moreover, to safely manipulate objects, it is necessary to recognize whether a target object is present within the field of view of a hand camera and manipulate the object only when the object is present within the field of view of the hand camera. Therefore, there is an increasing need for object tracking technology capable of explicitly determining the absence of a target object.

Meanwhile, the above-described background technology corresponds to technical information that has been possessed by the present inventor in order to contrive the present invention or that has been acquired in the process of contriving the present invention, and can not necessarily be regarded as known technology that had been known to the public prior to the filing of the present invention.

### DISCLOSURE

### Technical Problem

An object of one embodiment disclosed herein is to propose an object tracking device and method that enable a robot to become explicitly aware of whether a target object is absent in a video captured by a camera mounted on a robot.

An object of one embodiment disclosed herein is to propose an object tracking device and method that transmit a control signal intended to stop the movement of a robot upon detecting the absence of a target object.

### Technical Solution

As a technical solution for achieving the above-described object, according to one embodiment, there is disclosed an object tracking device including: memory configured to store data and an object tracking model; and a controller including at least one processor, and configured to determine whether a target object has exited from a frame image by using the object tracking model; wherein the frame image is a frame image of a video captured by a camera attached to a robot; and wherein the object tracking model includes: a transformer encoder configured to receive original features of the frame image extracted from the frame image and template features extracted from the initial and dynamic templates of the target object and output features of the frame image; a transformer decoder configured to receive the features of the frame image and a target query and output features of a target object query; a bounding box prediction head configured to predict the location coordinates of the bounding box of the target object within the frame image; a template update prediction head configured to predict whether the dynamic template of the target object needs to be updated; and an object exit prediction head configured to predict whether the target object has exited from the frame image.

According to another embodiment, there is disclosed an object tracking method that is performed by an object tracking device, the object tracking method including: extracting original features of a frame image from the frame image of a video captured by a camera attached to a robot, and also extracting template features from initial and dynamic templates of a target object; acquiring features of the frame image based on the original features of the frame image and the template features; acquiring features of a target object query based on the features of the frame image and a target query; predicting the location coordinates of the bounding box of the target object within the video image based on the features of the frame image and the features of the target object query; predicting whether the dynamic template of the target object needs to be updated based on the features of the target object query; and predicting whether the target object has exited from the frame image of the video based on the original features.

According to still another embodiment, there is disclosed a computer program that is performed by an object tracking device and performs an object tracking method, wherein the object tracking method includes: extracting original features of a frame image from the frame image of a video captured by a camera attached to a robot, and also extracting template features from initial and dynamic templates of a target object; acquiring features of the frame image based on the original features of the frame image and the template features; acquiring features of a target object query based on the features of the frame image and a target query; predicting the location coordinates of the bounding box of the target object within the video image based on the features of the frame image and the features of the target object query; predicting whether the dynamic template of the target object needs to be updated based on the features of the target object query; and predicting whether the target object has exited from the frame image of the video based on the original features.

According to still another embodiment, there is disclosed a computer-readable storage medium having recorded thereon a computer program that performs an object tracking method, wherein the object tracking method includes: extracting original features of a frame image from the frame image of a video captured by a camera attached to a robot, and also extracting template features from initial and dynamic templates of a target object; acquiring features of the frame image based on the original features of the frame image and the template features; acquiring features of a target object query based on the features of the frame image and a target query; predicting the location coordinates of the bounding box of the target object within the video image based on the features of the frame image and the features of the target object query; predicting whether the dynamic template of the target object needs to be updated based on the features of the target object query; and predicting whether the target object has exited from the frame image of the video based on the original features.

### Advantageous Effects

According to any one of the above-described technical solutions, it may be possible to explicitly determine whether a target object has exited from a frame image of a video captured by the camera mounted on the robot.

According to any one of the above-described technical solutions, it may be possible to transmit a signal intended to stop the movement of the robot when the exit of a target object is detected, thereby preventing the erroneous movement of the robot, and also preventing an accident that may occur due to the erroneous movement of the robot, so that a safe manipulation environment can be maintained.

The effects that may be obtained from the disclosed embodiments are not limited to the effects mentioned above, and other effects that are not mentioned may be clearly understood by those having ordinary skill in the art to which the disclosed embodiments pertain from the following description.

### DESCRIPTION OF DRAWINGS

FIG. 1 is a reference view illustrating an object tracking device according to one embodiment;

FIG. 2 is a block diagram showing the configuration of an object tracking device according to one embodiment;

FIG. 3 is a diagram showing the configuration of an object tracking model according to one embodiment;

FIG. 4 is a block diagram showing the configuration of an object exit prediction head according to an embodiment;

FIG. 5 shows graphs comparing the performance of an object tracking model according to one embodiment and the performance of an object tracking model without an object exit prediction head;

FIGS. 6 to 8 are diagrams illustrating the performance of an object tracking model according to one embodiment; and

FIG. 9 is a flowchart showing an object tracking method according to one embodiment.

### MODE FOR INVENTION

Various embodiments will be described in detail below with reference to the accompanying drawings. The following embodiments may be modified to various different forms and then practiced. In order to more clearly illustrate features of the embodiments, detailed descriptions of items that are well known to those having ordinary skill in the art to which the following embodiments pertain will be omitted. Furthermore, in the drawings, portions unrelated to descriptions of the embodiments will be omitted. Throughout the specification, like reference symbols will be assigned to like portions.

Throughout the specification, when one component is described as being “connected” to another component, this includes not only a case where the one component is ‘directly connected’ to the other component but also a case where the one component is ‘connected to the other component with a third component arranged therebetween.’ Furthermore, when one portion is described as “including” one component, this does not mean that the portion does not exclude another component but means that the portion may further include another component, unless explicitly described to the contrary.

Embodiments will be described in detail below with reference to the accompanying drawings.

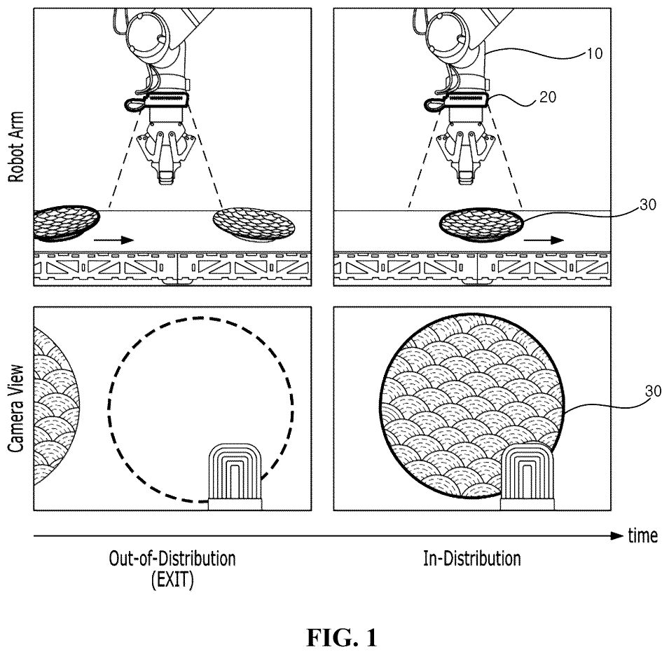

FIG. 1 is a reference view illustrating a robot control system using an object tracking device according to one embodiment. Referring to FIG. 1, the robot control system according to the one embodiment includes a robot 10, a camera 20, and an object tracking device (not shown).

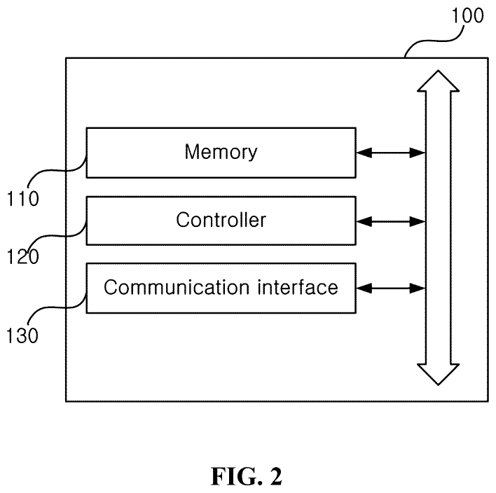

The object tracking device (not shown) according to one embodiment determines whether a target object is within the current frame of a video captured by a camera based on the video. When the target object is not within the current frame of the video, the object tracking device transmits a control signal intended to stop the movement the robot 10 to the drive unit of the robot. The object tracking device (not shown) may track the target object by using a transformer-based object tracking model. A related description will be given in detail in conjunction with FIG. 2.

The camera 20 may be attached to the robot, as shown in FIG. 1, to capture an image and transmit the captured image to the object tracking device. The images captured by the camera 20 may be a first-person perspective image. When the camera 20 is attached to an arm of the robot 10, the field of view may change depending on the movement of the arm.

FIG. 1 shows a case of the robot 10 that places sushi on dishes at a conveyor-belt sushi restaurant. The object tracking device (not shown) receives an image captured by the camera 20 attached to the arm of the robot 10, and, based on the received image, determines whether a dish 30, which is a target object, is within the current frame of the video.

Dishes, including the dish 30, which is a target object, may move on a conveyor belt. Initially, when the dish 30 is not within the current frame of the video, the object tracking device (not shown) may determine that the object has exited and transmits a control signal intended to stop the movement of the robot to a robot control device (not shown) that controls the movement of the robot. The robot control device (not shown) may be incorporated into the robot, or may be present separately from the robot.

As time passes, the dish 30 is located within the current frame of the video. The object tracking device (not shown) may determine the location of the dish 30 within the current frame of the video and transmit this information to the robot control device, and the robot 10 may place sushi on the dish.

According to one embodiment, the object tracking device may be incorporated into the robot 10, or may be present separately from the robot. When the object tracking device is present separately from the robot, it may transmit and receive control signals required for the operation of the robot or object location information over a network.

FIG. 2 is a block diagram showing the configuration of an object tracking device according to one embodiment.

Referring to FIG. 2, an object tracking device 100 according to one embodiment may include memory 110, a controller 120, and a communication interface 130.

The memory 110 may allow data and programs required for object tracking to be installed and stored therein. The memory 110 may be constructed via various types of memory. The memory 110 may store, as a program, an object tracking model that enables the controller 120, to be described later, to perform an object tracking method that can explicitly identify the exit of an object from a search region according to the process to be presented later, and may also store thresholds used in the object tracking model and data required for the training of the object tracking model.

The controller 120 is a component including at least one processor such as a CPU, a GPU, or the like, and may perform the object tracking method to be described later by executing a program stored in the memory 110. More specifically, the controller 120 may determine whether an object has exited from the frame image of a video based on a camera video received via the communication interface 130 to be described later, and may control other components included in the object tracking device 100 to perform a corresponding operation. When it is determined that an object has exited from the frame image of the video, the controller 120 may transmit a control signal intended to stop the robot to the drive unit of the robot via the communication interface 130. When an object is present within the frame image of the video, the controller 120 may transmit the location of the object to the robot control device via the communication interface 130. A method by which the controller 120 determines whether an object has exited and tracks an object based on a camera video, etc. will be described in detail below with reference to other drawings. Furthermore, in the present specification, the frame image of an (or the) video, the frame image of a (or the) camera video, and the frame image all refer to a (or the) frame image constituting a part of an image received from the camera.

The communication interface 130 may perform wired/wireless communication with another device or a network. For example, the communication interface 130 may operate to receive images captured by the camera and transmit control signals and the like to the robot control device. To this end, the communication interface 130 may include a communication module that supports at least one of various wired/wireless communication methods, and the communication module may be implemented in the form of a chipset. The wireless communication supported by the communication interface 130 may include, for example, Wireless Fidelity (Wi-Fi), Wi-Fi Direct, Bluetooth, Ultra-Wideband (UWB), Near Field Communication (NFC), and/or the like.

Depending on the embodiment, the object tracking device 100 may further include an input/output unit (not shown) for receiving input from an administrator or displaying information, such as whether an object has exited from the current frame of a video or the like, to the administrator. The input/output unit (not shown) may include various types of input devices (e.g., a keyboard, a touchscreen, a camera, etc.) for receiving input from a user, and may also include an output device such as a display panel, a speaker, and/or the like.

In the following description, an object tracking process, which is performed in such a manner that the controller 120 executes a program stored in the memory 110, according to one embodiment will be described in detail. Unless otherwise specified, the processes to be described later are each performed in such a manner that the controller 120 executes a program stored in the memory 110.

The controller 120 may implement an object tracking model, to be described later and used for object tracking, by executing a program stored in the memory 110. The controller 120 may input an image received from the camera attached to the arm of the robot, specifically a frame image of a camera video, to the object tracking model to output results such as whether an object has exited and the location of the object. When the object is predicted to have exited, the controller 120 may transmit a control signal intended to stop the robot to the robot control device that controls the movement of the robot, or may not transmit the location coordinates of the bounding box of the target object. In contrast, when the object is predicted not to have exited, the controller 120 may transmit the location coordinates of the bounding box of the target object.

In the following description, an image received from the camera attached to the arm of the robot is referred to as a video, and a frame image of the video is referred to as a frame image.

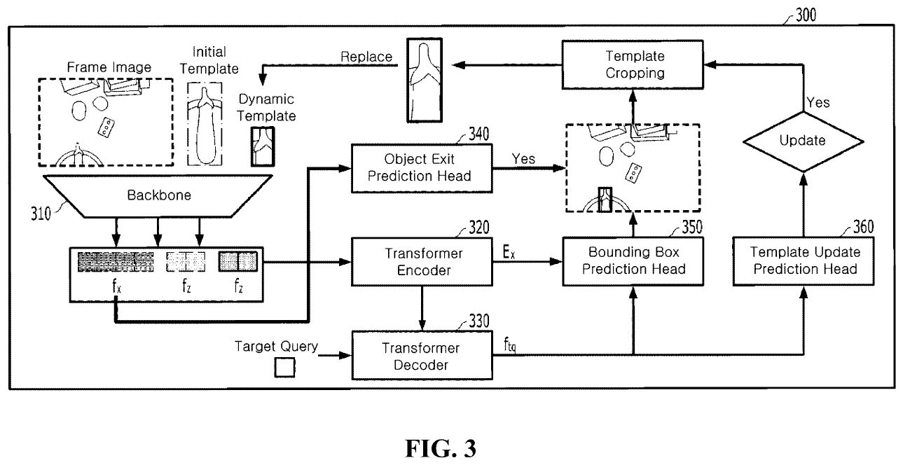

FIG. 3 is a diagram showing an object tracking model used to determine the location of an object and whether an object has exited in an object tracking device according to one embodiment. Referring to FIG. 3, an object tracking model 300 may include a backbone 310, a transformer encoder 320, a transformer decoder 330, an object exit prediction head 340, a bounding box prediction head 350, and a template update prediction head 360. The object tracking model 300 according to one embodiment may operate as a long-term tracker that fuses and updates target object information. Furthermore, in one embodiment, the object tracking model may be a single-object tracking model (or a single-object tracker) that tracks a single target object.

More specifically, the object tracking model 300 may receive a camera video, may extract frame image features and target object query features from the input image through the backbone 310, the transformer encoder 320, and transformer decoder 330, and may predict the location coordinates of the bounding box of a target object, whether a dynamic template needs to be updated, and whether the target object has exited (or whether the target object is absent) through the object exit prediction head 340, the bounding box prediction head 350, and the template update prediction head 360.

The backbone 310 includes a convolutional network, and outputs features of an input frame image in the form of a feature map. In other words, the backbone 310 may output original features fₓ of a frame image of a video, and template features including features of the initial and dynamic templates f_{z} of a target object.

The backbone 310 according to one embodiment receives a frame image of a video received from the camera attached to the robot, the initial template of the target object, and the dynamic template of the target object. Before inputting the frame image to the backbone 310, the controller 120 may preprocess a frame image to be input by introducing small disturbances into the frame image. This will be described later in conjunction with the object exit prediction head 340, which will be described later.

The dynamic template is used to capture the appearance of the target object over time and provide additional temporal information. The dynamic template may be updated by capturing an image of the target object within the frame image (template cropping). The updating of the dynamic template may occur every 10 to 200 frames, and may be performed in such a manner as to be merged into an existing template list.

The output original and template features of the frame image may be preprocessed so that they can be input to the transformer encoder 320, and then input to the transformer encoder 320. The transformer encoder 320 includes N encoder layers. As an example, the transformer encoder 320 may include six encoder layers. Each of the encoder layers may include a multi-head self-attention module entailing a feedforward network. The template and original features are input in the form of a feature sequence, and there may be output features Eₓ of the frame image overall modeled in both temporal and spatial dimensions.

The transformer decoder 330 may receive a single target query and the features Eₓ of the frame image output from the transformer encoder 320, and may output features f_{tq} of the target object query for identifying the location of the bounding box of the target object. The transformer decoder 330 includes M decoder layers. For example, the transformer decoder 330 may include six decoder layers. Each of the decoder layers may include a self-attention module, an encoder-decoder attention module, and a feedforward network. Since the object tracking model 300 is a single-object tracking model, the transformer decoder 330 uses a single target query.

The bounding box prediction head 350 may predict the location coordinates of the bounding box of the target object based on the features Eₓ of the frame image output from the transformer encoder 320 and the features f_{tq} of the target object query output from the transformer decoder 330. More specifically, to indicate which portion of the input frame image is similar to the template of the target object, a similarity score is calculated between the features of the frame image and the features of the target object query. Furthermore, the calculated similarity score may be input to a fully convolutional network (FCN) for predicting the top-left coordinates and a fully convolutional network for predicting the bottom-right coordinates. Then, by multiplying probability values, which are output values of the two fully convolutional networks, by the x and y coordinates of a search region, the top-left x and y coordinates of the bounding box of the target object within the search region and the bottom-right x and y coordinates of the bounding box of the target object may be obtained.

The template update prediction head 360 may receive the target query feature f_{tq} output from the transformer decoder 330 and predict a dynamic template update score intended to determine whether the dynamic template needs to be updated. The template update prediction head 360 may predict a template update prediction score by using a multi-layer perceptron (MLP). When the predicted template update prediction score is higher than a threshold, the dynamic template is predicted to need to be updated, and the image of the target object within the corresponding frame image may be updated to a dynamic template.

The dynamic template update score may be a value between 0 and 1, and the threshold may be, for example, 0.5.

The object exit prediction head 340 receives the original feature fₓ of the frame image output from the backbone 310, and predicts whether the target object is present within the frame image. More specifically, the object exit prediction score is calculated, and the target object is predicted to have exited (be absent) from the frame image when the calculated score is lower than the threshold. When the target object is predicted to have exited from the frame image, the controller 120 may transmit a control signal intended to stop the movement of the robot to the robot control device that controls the movement of the robot.

More specifically, the object exit prediction head 340 is implemented based on Equation 1, which classifies out-of-distribution samples.

$$p ( y \vert {d}_{in} , x ) = \frac{p ( y , {d}_{i n} \vert x )}{p ( {d}_{in} \vert x )} \qquad ( 1 )$$

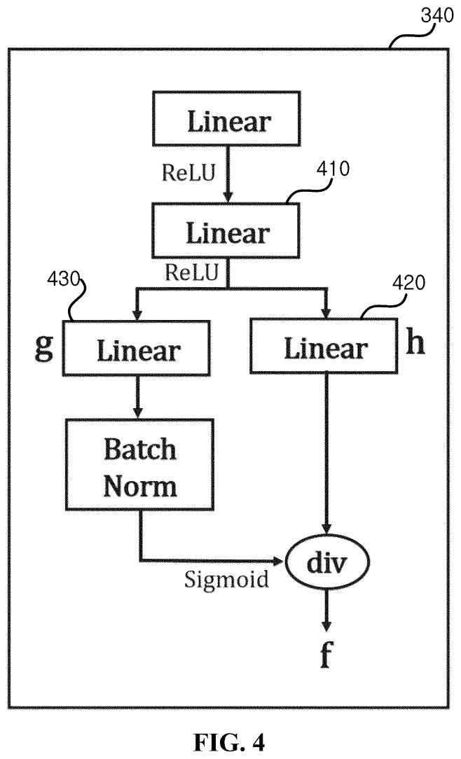

In Equation 1, the class posterior probability p(y|dᵢₙ,x) may be calculated based on the joint-class domain probability p(y, dᵢₙ|x) and the domain probability p(dᵢₙ|x). To more accurately predict whether the object has exited, it is preferable to learn the domain probability p(dᵢₙ|x) of the input data together with the class posterior probability p(y|dᵢₙ,x) rather than learning only the class posterior probability p (y|dᵢₙ,x). Accordingly, the object exit prediction head according to one embodiment may have a structure that predicts p(y|dᵢₙ,x) and p(dᵢₙ|x) separately, as shown in FIG. 4.

FIG. 4 is a block diagram showing the configuration of an object exit prediction head 340. FIG. 4 is implemented based on Equation 2, which corresponds to Equation 1. The object exit prediction head 340 may include a modified multi-layer perceptron (MLP) network that outputs a logit score fᵢ(x) for class I, as shown in Equation 2:

$${f}_{i} ( x ) = \frac{{h}_{i} ( x )}{g ( x )} \qquad ( 2 )$$

More specifically, the object exit prediction head 340 includes a linear layer 410 that receives the original features of the frame image output from the backbone 310, an h layer 420 that corresponds to hᵢ(x) in Equation 2 and calculates a probability for each classification class, and a g layer 430 that corresponds to g(x) in Equation 2 and calculates the domain probability distribution of the overall training data. The object exit prediction head 340 receives the features of the input frame image, calculates a probability for each classification class in the h layer 420, calculates a domain probability in the g layer 430, and calculates the logit score fᵢ(x) based on these calculated values. The calculated logit score fᵢ(x) may function as the object exit prediction score. The controller 120 compares the object exit prediction score with a threshold. When the object exit prediction score is lower than the threshold, the target object is predicted not to be present in the frame image.

Meanwhile, to improve the accuracy of the object exit prediction head 340 as described above, the controller 120 may perform a perturbation process that introduces small disturbances into a frame image of a video to be input to the backbone 310. The perturbation process may be performed using Equation 3 below. After training the object tracking model, the controller 120 may determine the perturbation intensity E and the threshold used to determine whether an object has exited during a testing process. During the perturbation process, S(x) may generally be the maximum value of hᵢ(x) and g(x).

$$S ( x ) = {max}_{i} {h}_{i} ( x ) or g ( x ) \qquad ( 3 )$$

$$\hat{x} = x - ϵ sign ( - {∇}_{x} S ( x ) )$$

$${ϵ}^{*} = arg {max}_{ϵ} {\sum }_{x ∈ {D}_{in}^{val}} S ( \hat{x} )$$

Referring to Equation 3, the perturbation process may obtain S(x) and output \hat{x}, obtained by manipulating the frame image x of the camera video, which is an image input to the backbone, by using S(x). In this case, an appropriate value may be selected as the perturbation intensity E after inputting and applying various values as the perturbation intensity E during the testing process in order to ensure that the object exit prediction score of the frame image where the target object has exited and the object exit score of the frame image which contains the target object have distinctively different values, resulting in a dichotomous classification.

Meanwhile, to select a threshold used to determine whether an object has exited, a score function needs to be consistent and stable. However, there is a problem in that the output values of the score function are not constrained such that values in a specific range become values in a preset range. Furthermore, since the original features of the frame image input to the object exit prediction head 340 are time-series data, object exit prediction scores need to be consistent. Accordingly, the controller 120 may determine the moving average of the object exit prediction scores over a specific period to be a final object exit prediction score used to determine whether an object has exited. Whether the object has exited may be determined by comparing the final object exit prediction score with a threshold. The threshold used for object exit prediction may be determined by reflecting therein changes in the final object exit prediction score.

The controller 120 may train the object tracking model 300 based on data collected from an environment in which the robot will be used. More specifically, the controller 120 may input collected image data to the backbone 310, may input original features of a frame image and template features of a target object, output from the backbone 310, to the transformer encoder 320, and may train the bounding box prediction head 350 and the template update prediction head 360 by using output values of the transformer encoder 320 and the transformer decoder 330 and, simultaneously, train the object exit prediction head 340 by using the original features of the frame image. The reason for this is that the performance of the prediction heads in the case where the object exit prediction head 340, the bounding box prediction head 350, and the template update prediction head 360 are trained simultaneously is superior to that of a two-step training method in which the bounding box prediction head 350 is trained first and then the template update prediction head 360 and the object exit prediction head 340 are trained. This will be described further below.

Table 1 shows experimental results for identifying the most effective features for object exit prediction for input images. In Table 1, EXOT (EXit-aware Object Tracker) refers to the object tracking model 300 according to the one embodiment shown in FIG. 3, and EXOTm, EXOTm-s, EXOT-s, EXOT-e, and EXOT-tq are object tracking models having the same configuration as EXOT. However, EXOT and EXOTm use original features fₓ of the frame image as input to the object exit prediction head 340, whereas EXOT-s and EXOTm-s use similarity scores as input to the object exit prediction head 340 as in the case of the boundary prediction head 350, EXOT-e inputs the output Eₓ of the transformer encoder to the object exit prediction head 340, and EXOT-tq uses features f_{tq} of the target query as input.

Furthermore, EXOTm and EXOT differ in their methods for training the object tracking model. EXOTm simultaneously trains the object exit prediction head 340, the bounding box prediction head 350, and the template update prediction head 360 during the training of the object tracking model. EXOT uses a two-step training method: the bounding box prediction head 350 is trained first, and then the object exit prediction head 340 and the template update prediction head 360 are trained. Likewise, EXOTm-s and EXOT-s use the above methods: EXOTm-s trains the prediction heads simultaneously and EXOT-s uses the two-step training method.

TABLE 1

| Dataset | Metric | EXOTm | EXOTm-s | EXOT | EXOT-e | EXOT-s | EXOT-tq | STARK |
|---|---|---|---|---|---|---|---|---|
| TREK-150 | FPR | 0.82 | 0.98 | 0.91 | 0.99 | 0.94 | 0.98 | 0.97 |
| | AUROC | 0.41 | 0.35 | 0.17 | 0.10 | 0.25 | 0.14 | 0.03 |
| | AUC (%) | 66.58 | 67.39 | 22.93 | 22.85 | 25.71 | 22.53 | 69.33 |
| | OP75 (%) | 66.31 | 63.82 | 10.41 | 10.65 | 9.71 | 10.31 | 68.56 |
| | Pₙₒᵣₘ (%) | 87.27 | 89.31 | 30.14 | 29.90 | 35.31 | 30.01 | 90.27 |
| RMOT-223 | FPR | 0.78 | 0.74 | 1.00 | 0.86 | 0.71 | 0.96 | 1.00 |
| | AUROC | 0.25 | 0.38 | 0.08 | 0.22 | 0.45 | 0.22 | 0.00 |
| | AUC (%) | 74.56 | 72.64 | 73.55 | 70.31 | 72.23 | 73.08 | 71.25 |
| | OP75 (%) | 80.76 | 78.07 | 79.02 | 74.93 | 78.03 | 78.16 | 75.94 |
| | Pₙₒᵣₘ (%) | 97.85 | 95.57 | 97.56 | 93.44 | 96.50 | 96.94 | 94.00 |

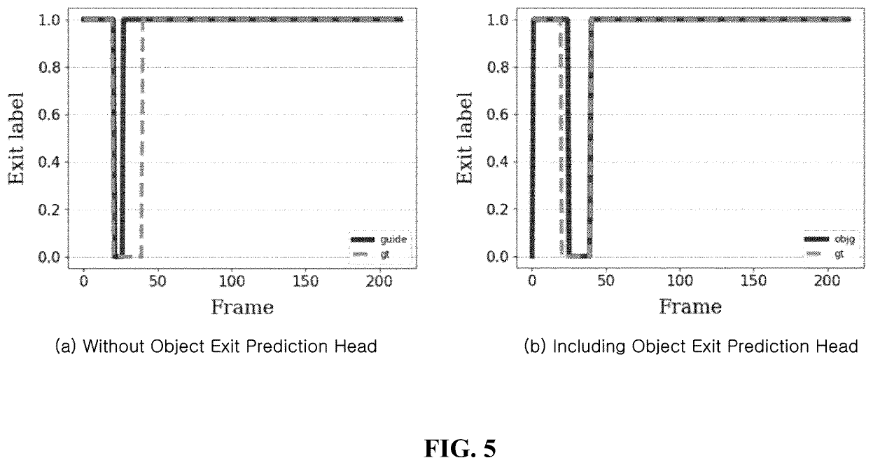

FIG. 5 shows graphs comparing the performance of an object tracking model according to one embodiment and the performance of an object tracking model without an object exit prediction head. In FIG. 5, the solid line indicates that the object tracking model predicted whether an object would exit, and the dotted line indicates whether an object has actually exited (is absent) from the frame image. As the shapes of the two graphs become more similar, the accuracy of object exit prediction increases. Referring to FIG. 5, it can be seen that the object tracking model including an object exit prediction head according to the one embodiment has a higher accuracy of object exit prediction.

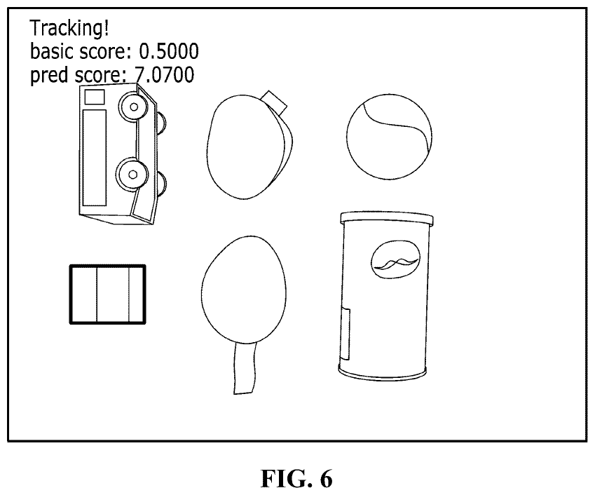

In the same manner, FIGS. 6 to 8 are diagrams illustrating the performance of an object tracking model according to one embodiment. FIG. 6 is a diagram showing a case where a block, which is a target object, is located within a frame image. Referring to FIG. 6, when the target object is predicted to be present within the frame image, a rectangular bounding box is marked outside the block, which is a target object.

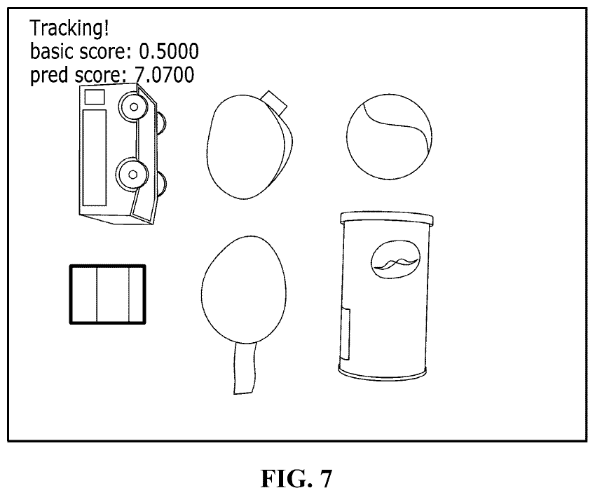

FIG. 7 is a diagram showing an object exit prediction result of an object tracking model according to one embodiment. Referring to FIG. 7, it can be seen that a block, which is a target object, is accurately predicted to be absent within a frame image, so that a rectangular bounding box is not marked.

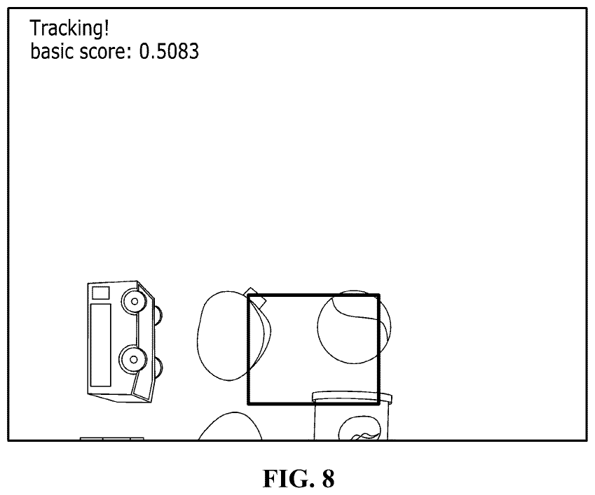

FIG. 8 is a diagram showing an object exit prediction result of an object tracking model without an object exit prediction head. Referring to FIG. 8, it can be seen that, even though a block, which is a target object, is not present in a frame image, the target object is determined to be present within the frame image, so that a rectangular bounding box is marked.

According to the above description, the object tracking device according to the one embodiment may explicitly determine whether a target object has exited from a frame image of a video captured by the camera mounted on the robot, and may transmit a signal intended to stop the movement of the robot when the exit of a target object is detected, thereby preventing the erroneous movement of the robot, and also preventing an accident that may occur due to the erroneous movement of the robot, so that a safe manipulation environment can be maintained.

The term “unit” used in the above-described embodiments means software or a hardware component such as a field-programmable gate array (FPGA) or application-specific integrated circuit (ASIC), and a “unit” performs a specific role. However, a “unit” is not limited to software or hardware. A “unit” may be configured to be present in an addressable storage medium, and also may be configured to run one or more processors. Accordingly, as an example, a “unit” includes components, such as software components, object-oriented software components, class components and task components, processes, functions, attributes, procedures, subroutines, segments in program code, drivers, firmware, microcode, circuits, data, a database, data structures, tables, arrays, and variables.

Components and a function provided in “unit(s)” may be coupled to a smaller number of components and “unit(s)” or may be divided into a larger number of components and “unit(s).” In addition, components and “unit(s)” may be implemented to run one or more central processing units (CPUs) in a device or secure multimedia card.

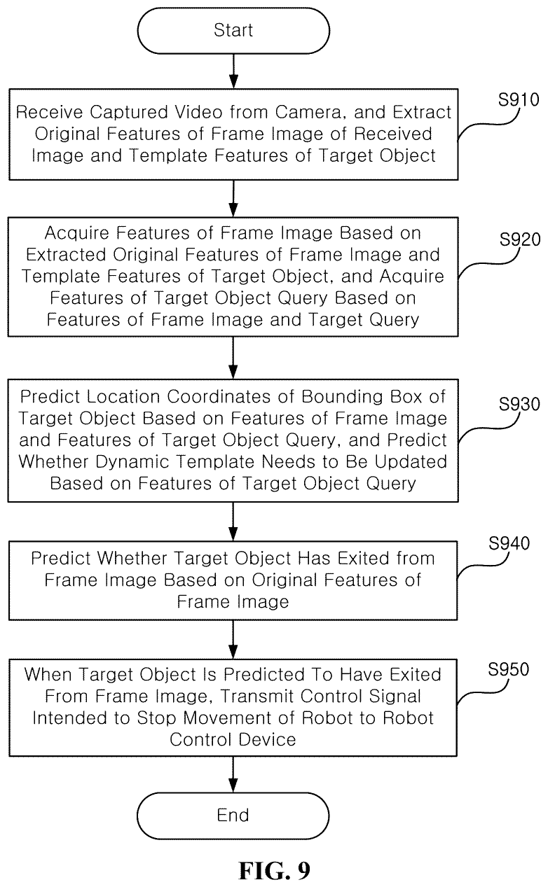

Meanwhile, FIG. 9 is a flowchart showing an object tracking method according to one embodiment. The object tracking method of FIG. 9 includes the steps that are processed in a time-series manner by the object tracking device 100 shown in FIGS. 1 to 8. Accordingly, the partial descriptions that are omitted but have been given in conjunction with the object tracking device 100 shown in FIGS. 1 to 8 may also be applied to the object tracking method according to the embodiment shown in FIG. 9.

Referring to FIG. 9, the object tracking device 100 may receive a captured image from a camera, may acquire original features of a frame image based on the frame image of the received video, and may acquire template features of a target object based on the initial and dynamic templates of the target object in step S910. In this case, the object tracking device 100 may preprocess the frame image through a perturbation process using Equation 3 and then acquire original features of the preprocessed frame image.

Next, the object tracking device 100 may acquire features of the frame image based on the original features of the frame image and the template features of the target object and acquire features of a target object query based on the acquired features of the frame image and the target object query in step S920.

Then, the object tracking device 100 may predict the location coordinates of the bounding box of the target object based on the features of the frame image and the features of the target object query and predict whether the dynamic template needs to be updated based on the features of the target object query in step S930. The object tracking device 100 may calculate a template update prediction score by using a multi-layer perceptron (MLLP) based on the features of the target object query. When the calculated template update prediction score is higher than a threshold, the object tracking device 100 may predict that the dynamic template needs to be updated. When the dynamic template is predicted to need to be updated, the object tracking device 100 updates the target object image of the corresponding frame image to a dynamic template, and the updated dynamic template may be added to an existing template list.

Meanwhile, the object tracking device 100 predicts whether the target object has exited (is absent) from the frame image based on the original features of the frame image in step S940. When the target object is predicted to have exited from the frame image, the object tracking device 100 may transmit a control signal intended to stop (halt) the movement of the robot to the robot control device in step S950. The object tracking device 100 may acquire an object exit prediction score based on Equations 1 and 2, may compare the predicted object exit prediction score with a threshold, and may predict that the target object is not present in the frame image when the object exit prediction score is lower than the threshold. Although step S940 is shown as a step separate from step S930, the two steps may be performed simultaneously.

The object track method according to the embodiment described in conjunction with FIG. 9 may be implemented in the form of a computer-readable medium that stores instructions and data that can be executed by a computer. In this case, the instructions and the data may be stored in the form of program code, and may generate a predetermined program module and perform a predetermined operation when executed by a processor. Furthermore, the computer-readable medium may be any type of available medium that can be accessed by a computer, and may include volatile, non-volatile, separable and non-separable media. Furthermore, the computer-readable medium may be a computer storage medium. The computer storage medium may include all volatile, non-volatile, separable and non-separable media that store information, such as computer-readable instructions, a data structure, a program module, or other data, and that are implemented using any method or technology. For example, the computer storage medium may be a magnetic storage medium such as an HDD, an SSD, or the like, an optical storage medium such as a CD, a DVD, a Blu-ray disk or the like, or memory included in a server that can be accessed over a network.

Furthermore, the object track method according to the embodiment described in conjunction with FIG. 9 may be implemented as a computer program (or a computer program product) including computer-executable instructions. The computer program includes programmable machine instructions that are processed by a processor, and may be implemented as a high-level programming language, an object-oriented programming language, an assembly language, a machine language, or the like. Furthermore, the computer program may be stored in a tangible computer-readable storage medium (for example, memory, a hard disk, a magnetic/optical medium, a solid-state drive (SSD), or the like).

Accordingly, the object track method according to the embodiment described in conjunction with FIG. 9 may be implemented in such a manner that the above-described computer program is executed by a computing apparatus. The computing apparatus may include at least some of a processor, memory, a storage device, a high-speed interface connected to memory and a high-speed expansion port, and a low-speed interface connected to a low-speed bus and a storage device. These individual components are connected using various buses, and may be mounted on a common motherboard or using another appropriate method.

In this case, the processor may process instructions within a computing apparatus. An example of the instructions is instructions which are stored in memory or a storage device in order to display graphic information for providing a Graphic User Interface (GUI) onto an external input/output device, such as a display connected to a high-speed interface. As another embodiment, a plurality of processors and/or a plurality of buses may be appropriately used along with a plurality of pieces of memory. Furthermore, the processor may be implemented as a chipset composed of chips including a plurality of independent analog and/or digital processors.

Furthermore, the memory stores information within the computing device. As an example, the memory may include a volatile memory unit or a set of the volatile memory units. As another example, the memory may include a non-volatile memory unit or a set of the non-volatile memory units. Furthermore, the memory may be another type of computer-readable medium, such as a magnetic or optical disk.

In addition, the storage device may provide a large storage space to the computing device. The storage device may be a computer-readable medium, or may be a configuration including such a computer-readable medium. For example, the storage device may also include devices within a storage area network (SAN) or other elements, and may be a floppy disk device, a hard disk device, an optical disk device, a tape device, flash memory, or a similar semiconductor memory device or array.

The above-described embodiments are intended for illustrative purposes. It will be understood that those having ordinary knowledge in the art to which the present invention pertains can easily make modifications and variations without changing the technical spirit and essential features of the present invention. Therefore, the above-described embodiments are illustrative and are not limitative in all aspects. For example, each component described as being in a single form may be practiced in a distributed form. In the same manner, components described as being in a distributed form may be practiced in an integrated form.

The scope of protection pursued through the present specification should be defined by the attached claims, rather than the detailed description. All modifications and variations which can be derived from the meanings, scopes and equivalents of the claims should be construed as falling within the scope of the present invention.

What is claimed is:

1. An object tracking device for a robot that manipulates a moving object, the object tracking device comprising:
memory configured to store data and an object tracking model; and
a controller including at least one processor, and configured to determine whether a target object has exited from a frame image by using the object tracking model;
wherein the frame image is a frame image of a video captured by a camera attached to a robot; and
wherein the object tracking model comprises:
a transformer encoder configured to receive original features of the frame image extracted from the frame image and template features extracted from initial and dynamic templates of the target object and output features of the frame image;
a transformer decoder configured to receive the features of the frame image and a target query and output features of a target object query;
a bounding box prediction head configured to predict location coordinates of a bounding box of the target object within the frame image;
a template update prediction head configured to predict whether the dynamic template of the target object needs to be updated; and
an object exit prediction head configured to predict whether the target object has exited from the frame image.

2. The object tracking device of claim 1, wherein the object tracking model is a single-object tracking model that tracks a single target object.

3. The object tracking device of claim 1, wherein the controller simultaneously trains the object exit prediction head, the bounding box prediction head, and the template update prediction head.

4. The object tracking device of claim 1, wherein the object exit prediction head calculates an object exit prediction score based on the original features of the frame image, and predicts that the target object has exited when the calculated object exit prediction score is lower than a threshold.

5. The object tracking device of claim 1, wherein the controller transmits a control signal intended to stop a movement of the robot to a robot control device when the object exit prediction head predicts that the target object has exited from the frame image.

6. An object tracking method that is performed by an object tracking device, the object tracking method comprising:
extracting original features of a frame image from the frame image of a video captured by a camera attached to a robot, and also extracting template features from initial and dynamic templates of a target object;
acquiring features of the frame image based on the original features of the frame image and the template features;
acquiring features of a target object query based on the features of the frame image and a target query;
predicting location coordinates of a bounding box of the target object within the video image based on the features of the frame image and the features of the target object query;
predicting whether the dynamic template of the target object needs to be updated based on the features of the target object query; and
predicting whether the target object has exited from the frame image of the video based on the original features.

7. The object tracking method of claim 6, wherein determining whether the target object has exited, predicting whether the dynamic template of the target object needs to be updated, and predicting the location coordinates of the bounding box of the target object are performed simultaneously.

8. The object tracking method of claim 6, wherein an object exit prediction score is calculated based on the original features, and the target object is predicted to have exited when the calculated object exit prediction score is lower than a threshold.

9. The object tracking method of claim 6, further comprising, when the target object is predicted to have exited from the frame image in predicting whether the target object has exited, transmitting a control signal intended to stop a movement of the robot to a robot control device.

10. A computer program that is performed by an object tracking device and performs the method set forth in claim 6.

11. A computer-readable storage medium having recorded thereon a computer program that performs the method set forth in claim 6.
